(19) United States
(12) Patent Application Publication
(10) Pub. No.: US 2024/0011526 A1
(43) Pub. Date: Jan. 11, 2024

(54) STABILIZING LONG AND SLENDER TOOLS BY HYDROSTATIC BEARING EFFECT

(71) Applicant: Kennametal Inc., Latrobe, PA (US)

(72) Inventors: Ruy Frota de Souza Filho, Latrobe, PA (US); Dominik Schmid, Latrobe, PA (US)

(21) Appl. No.: 17/811,429

(22) Filed: Jul. 8, 2022

(51) Int. Cl. F16C 32/06; B23Q 11/10

(52) U.S. Cl. CPC F16C 32/06; B23Q 11/10; F16C 2322/39

(57) ABSTRACT

A cutting tool is provided having a hydrostatic bearing support to minimize bending of the tool when in use. More specifically, a tool is provided comprising a body, a cutting insert, at least one flow pressure supply channel, a hydrostatic bearing, and wherein the flow pressure supply channel is in communication with the hydrostatic bearing, and optionally at least one coolant channel in communication with the cutting insert, and wherein the flow pressure supply channel is in communication with a supply reservoir for containing a lubricant or coolant. The supply reservoir is ultimately in communication with a pump to supply pressure to the hydrostatic bearing when the tool is operational.

### CROSS-REFERENCE TO RELATED APPLICATION

Not applicable.

### STATEMENT REGARDING FEDERALLY SPONSORED RESEARCH OR DEVELOPMENT

Not Applicable.

### BACKGROUND OF THE INVENTION

### 1. Field of the Invention

The present invention relates to a tool that is stabilized by an additional support of a hydrostatic bearing in communication with a coolant lubricant supplied by the machine tool. In certain embodiments of this invention, the tool may be a long and slender tool that is subject to lateral forces that accumulate to a significant bending moment resulting in tool instability. The hydrostatic bearing is preferably positioned in the tool close to a cutting blade or drill tip.

### 2. Description of the Background Art

Depending on the work piece geometry, the use of long and slender cutting tools is required. Those tools can be problematic as the lateral forces can accumulate to s significant bending moment resulting in tool instability. One prominent example for this issue are cut-off-blades. This bending moment (and with this the instability) can be significantly reduced if the tool is supported at an additional position close to the cutting insert. Thus, there is a need to prevent the tools from developing a relative bending moment that results in instability of the tool. The background art discloses technology such as a rotary drill bit for earth comprising a bit body and a bit. The gauge of the bit is provided with bearing pads that have a cavity where drilling fluid is delivered, which acts as a low friction hydrostatic bearing surface. Other background art discloses a rotary drill bit having a low friction bearing pad includes an outwardly facing cavity which is connected to the passage by a choked conduit so that, in use, drilling fluid under pressure is delivered to the cavity, which thereby acts as a low friction hydrostatic bearing surface.

Other background art describe a subterranean drill bit having a plurality of cutting elements and a gauge portion of the bit that has a hydrostatic bearing that facilitates the rotation of the bit which avoids backwards whirling of the bit.

This invention incorporating an additional support of a hydrostatic bearing feed by a coolant lubricant supplied by the machine tool to a metal cutting tool or a turning tool. For maximum efficiency, the hydrostatic bearing should be as close as possible to where the forces are induced—which is in most cases the cutting region. Using additive manufacturing these features can be created with very limited additional cost.

### SUMMARY OF THE INVENTION

A cutting tool is provided having a hydrostatic bearing feed.

In a certain embodiment of this invention, a cutting tool is provided comprising a hydrostatic bearing support to prevent bending of the tool when in use. In certain embodiments of this invention, the cutting tool is a metal cutting tool, such as for example but not limited to, a turning tool.

In another embodiment of this invention, a tool is provided comprising a body, a cutting insert that is positioned at least partially within or on a first end of said body, at least one flow pressure supply channel positioned within at least a portion of an internal area of said body, wherein said flow pressure supply channel has a first end and a second end that is opposite to the first end of said flow pressure supply channel, a hydrostatic bearing positioned in the internal area of the body, wherein said first end of the flow pressure supply channel is in fluid communication with said hydrostatic bearing, and wherein said second end of the flow pressure supply channel is in fluid communication with a reservoir supply. The reservoir supply is in fluid communication with a pump, and wherein said pump is either a part of said tool or is external to said tool, and wherein said pump transfers a lubricant or coolant under pressure to said reservoir supply through said flow pressure supply channel and to said hydrostatic bearing. The hydrostatic bearing is in fluid communication with at least one of said body of said tool and said cutting insert.

In certain other embodiments of this invention, a tool is provided comprising a body, said body having a width, a length, and a height forming an internal area of said body, said body having a first end and a second end, and a middle section disposed between said first send and said second end of said body, a cutting insert having a first end and a second end that is opposite to the first end of said cutting insert, wherein said cutting insert is positioned at least partially on or within the first end of the body, and wherein said cutting insert has a cutting edge, a first flow pressure supply channel and a second flow pressure supply channel that are each positioned within at least a portion of said internal area of said body of said tool, wherein said each of said first flow pressure supply channel and said second flow pressure supply channel has a first end and a second end that is opposite to the first end of each of said first pressure supply channel and said second flow pressure supply channel, respectively, a hydrostatic bearing positioned in said internal area of said body, said hydrostatic bearing has a first side recess and a second side recess, wherein said first side recess is opposite to said second side recess, said hydrostatic bearing has a first orifice and a second orifice, said first orifice is opposite to said second orifice, and wherein said first orifice is in fluid communication with said first end of said first flow pressure supply channel, and said second orifice is in fluid communication with said first end of said second flow pressure supply channel, and wherein said hydrostatic bearing has at least one land, and wherein said first side recess and said second side recess are in fluid communication with at least a portion of said cutting insert and optionally a portion of said body, and wherein said first flow pressure supply channel and said second flow pressure supply channel are in fluid communication with a reservoir supply. The reservoir supply is in fluid communication with a reservoir supply conduit, wherein said reservoir supply conduit is in fluid communication with a pump, wherein said pump is either a part of said tool or is external to said tool, and wherein said pump transfers a lubricant or coolant under pressure to said reservoir supply through at least one of said first flow pressure supply channel and said second flow pressure supply channel and to said hydrostatic bearing. The tool, optionally includes at least one coolant channel positioned within a portion of said internal area of said body, wherein said coolant channel has a first end and a second end that is opposite to said first end, and wherein said first send of said coolant channel is in fluid communication with said cutting insert and wherein said second end of said coolant channel is in fluid communication with a supply reservoir. The reservoir supply is in fluid communication with a pump, wherein said pump is either a part of said tool or is external to said tool, and wherein said pump transfers a lubricant or coolant under pressure to said reservoir supply through said coolant channel and to said cutting insert. In certain other embodiments of this invention, the tool includes wherein said second end of said cutting insert is positioned within the body of the tool, and wherein a portion of said first end of said cutting insert and said cutting edge of the cutting insert protrude beyond said first end of said body. The tool includes wherein said supply reservoir contains a fluid that is a lubricant or a cooling lubricant. The tool includes wherein a hydrostatic effect occurs between said first end of said cutting insert and a workpiece when said tool is in operation.

In another embodiment of this invention, a tool is provided comprising a body, a cutting insert located on or within at least a portion of said body, at least one flow pressure supply channel located within said body, and a hydrostatic bearing located within said body, and wherein said flow pressure supply channel is in fluid communication with said hydrostatic bearing, and wherein said flow pressure supply channel is in fluid communication with a reservoir supply. The reservoir supply is in fluid communication with a pump. The pump is either a part of said tool or is external to said tool, and wherein said pump transfers a lubricant or coolant under pressure to said reservoir supply through said flow pressure supply channel and to said hydrostatic bearing. Optionally, the tool includes at least one coolant channel that is in fluid communication with said cutting insert and said reservoir supply. The reservoir supply is in fluid communication with a pump. The pump is either a part of said tool or is external to said tool, and wherein said pump transfers a lubricant or coolant under pressure to said reservoir supply through said coolant channel and to said cutting insert.

In certain embodiments of this invention, the tool is produced, for example but not limited to, by using additive manufacturing. The tool is made of, for example but not limited to, hardened metal, tungsten carbide, or cobalt.

In another embodiment, a cutting tool is provided comprising a hydrostatic bearing support to prevent bending of the tool when in use.

In certain embodiments of this invention, the tool of this invention is a metal cutting tool, such as for example but not limited to, a turning tool or a drill.

In another embodiment of this invention, a metal cutting tool is provided comprising a body, said body having a cutting edge or an interface for a cutting insert, at least one channel supplying a pressurized fluid from a machine tool to a section where said metal cutting tool is engaging with a workpiece, and at least one orifice that is in fluid communication with at least one said channel to form at least one hydrostatic fluid bearing, wherein said hydrostatic fluid bearing is created between said workpiece and said metal cutting tool, and wherein said hydrostatic fluid bearing having a stabilizing effect on said metal cutting tool. In certain embodiments, the metal cutting tool wherein said one or more orifices that result in a hydrostatic bearing effect are arranged in a way that each resulting force of said hydrostatic fluid bearing are in balance. In certain embodiments, the metal cutting tool wherein one or more of said orifices that result in a hydrostatic bearing effect are arranged in a way that one or more forces of one or more of said hydrostatic fluid bearings are balanced by other forces selected from the group of the bending of said metal cutting tool. In certain embodiments, the metal cutting tool wherein each of said orifices are located in proximity to said section that is a cutting region. In certain embodiments, the metal cutting tool has a shape that has a length that is long and slender compared to the metal cutting tool's width, having a length to a width diameter ratio greater than 5. In certain embodiments, the metal cutting tool wherein one or more of said orifices are strictly opposed to each other. In certain embodiments, the metal cutting tool wherein two or more of said orifices are slightly set off from each other to accommodate for design space limitations. In certain embodiments, the metal cutting tool employs a coolant lubricant of a machine tool that is used in a metal cutting process, as a fluid to pressurize one or more of said hydrostatic fluid bearings

These and other embodiments of this invention shall be described in more detail herein and in the drawings that show certain embodiments of this invention.

### BRIEF DESCRIPTION OF THE DRAWINGS

While various embodiments of this invention are illustrated in the drawings, the particular embodiments shown should not be construed to limit the claims. Various modifications and changes may be made without departing from the scope of the invention.

FIG. 1 shows the benefits to a bending moment when using a hydrostatic bearing in a slender tool of this invention.

FIG. 2 shows an embodiment of a side cross sectional view of the tool of this invention.

FIG. 3 shows the gap (70) between a tool cut-off blade (cutting insert 16) without a hydrostatic bearing (FIG. 3 left) and with a hydrostatic bearing (FIG. 3 right (i.e. this invention)), and a metal workpiece (50). FIG. 3 (right) shows the film (90) of the lubricant and the hydrostatic bearing effect of a tool of this invention.

FIG. 4 shows a side exterior view of a tool of this invention that is a modular drill tip having a hydrostatic bearing of this invention.

FIG. 5 shows a schematic of a certain embodiment of this invention wherein one flow pressure supply channel (19) is provided in the tool (1) of this invention. The single flow pressure supply channel (19) shown has two exits (80, 82). The gap (70) between the cutting insert (16) and a metal workpiece (50) is shown.

FIG. 6 shows an enlarged partial view of FIG. 2 of the internal area (10) of the body (3) of a certain embodiment of the tool (1) of this invention.

FIG. 7 shows an embodiment of a metal cutting tool (100) of this invention.

FIG. 8 shows an embodiment of a metal cutting tool (100) of this invention and a workpiece (500).

### DETAILED DESCRIPTION OF THE INVENTION

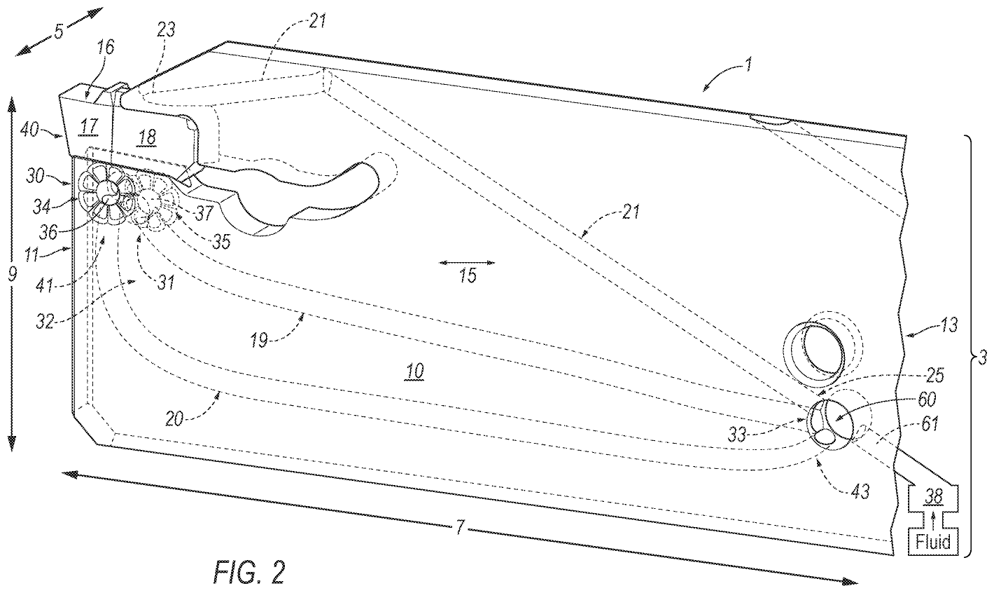

As set forth in FIG. 2, a cutting tool (1) is provided having a hydrostatic bearing (30).

As shown in FIG. 2, a certain embodiment of this invention provides a cutting tool (1) comprising a hydrostatic bearing support (30) to minimize bending of the tool (1) when in use. In certain embodiments of this invention, the cutting tool (1) is a metal cutting tool. The metal cutting tool may be, for example but not limited to, a turning tool.

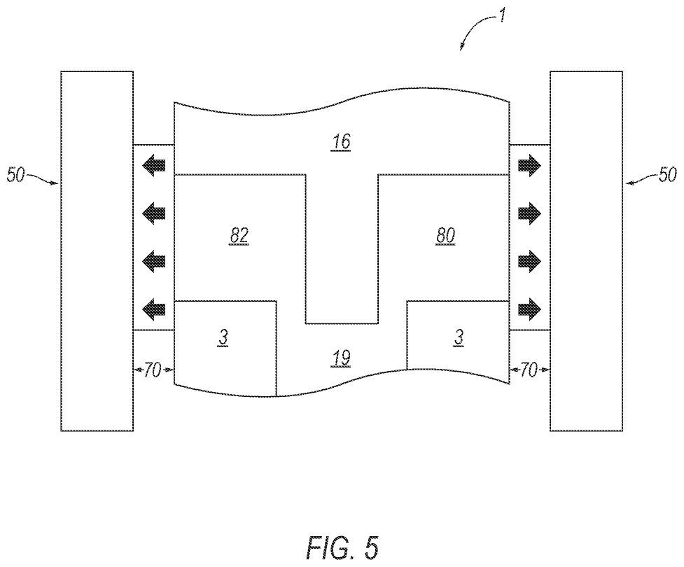

FIGS. 2, 3, and 5 show a certain embodiment of this invention, wherein a tool (1) is provided comprising a body (3), a cutting insert (16), at least one flow pressure supply channel (19, 20), a hydrostatic bearing support (30), and wherein said flow pressure supply channel (19, 20) is in fluid communication with said hydrostatic bearing support (30), and an optional coolant channel (21) that is in juxtaposition to and in fluid communication with said cutting insert (16), and wherein said flow pressure supply channel (19, 20) is in fluid communication with said hydrostatic bearing support (30) and a coolant supply reservoir (60). The coolant supply reservoir (60) is in fluid communication with a coolant conduit (61). The coolant conduit (61) is in fluid communication with a pump (38) or other flow/pressure device (not shown). The pump (38) or other flow/pressure device are elements that are known to those persons of ordinary skill in the art that customarily may be supplied with a cutting tool or turning tool for supplying fluid (i.e. lubricant or cooling lubricant) to the tool. In certain embodiments of this invention, the tool (1) is a metal cutting tool, such as for example but not limited to, a turning tool. In certain embodiments of this invention, the cutting insert (16) of the tool (1) is either a blade or a drill tip. FIG. 5 shows a certain embodiment of this invention, wherein the tool (1) has one flow pressure supply channel (19) and wherein said flow pressure supply channel (19) is bifurcated into two separate exit channels (82, 80).

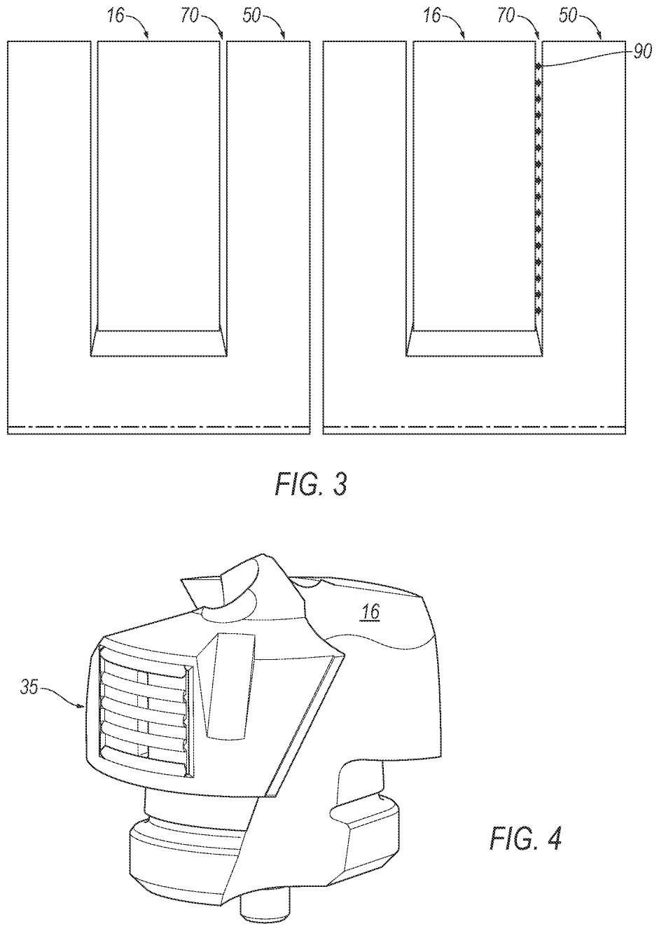

FIGS. 2, 4, and 6 illustrate a certain embodiment of this invention providing a tool (1) comprising a body (3), the body (3) having a width (5), a length (7), and a height (9) forming an internal area (10) of the body (3), the body (3) having a first end (11) and a second end (13), and a middle section (15) disposed between said first send (11) and said second end (13). The tool (1) has a cutting insert (16) having a first end (17) and a second end (18) that is opposite to the first end (17), wherein the cutting insert (16) is positioned at least partially on or within the first end (11) of the body (3). The cutting insert (16) has a cutting edge (40). In certain embodiments of this invention, the second end (18) of the cutting insert (16) is positioned within the body (3) of the tool (1), and wherein a portion of the first end (17) of the cutting insert (16) and the cutting edge (40) of the cutting insert (16) protrude beyond the first end (11) of the body (3) of the tool (1). The tool (1) has at least one flow pressure supply channel (19, 20) positioned within at least a portion of the internal area (10) of the body (3) of the tool (1). The flow pressure supply channel (19, 20) has a first end (31, 41, respectively) and a second end (33, 43, respectively) that is opposite to the first end (31, 41, respectively) of the flow pressure supply channel (19, 20, respectively). The tool (1) has a hydrostatic bearing support (30) positioned in the internal area (10) of the body (3). The hydrostatic bearing support (30) has a first side recess (34) and a second side recess (35), wherein said first side recess (34) is opposite to said second side recess (35). The hydrostatic bearing support (30) has a first orifice (36) and a second orifice (37), said first orifice (36) is opposite to said second orifice (37). The first orifice (36) is in fluid communication with the first end (41) of the flow pressure supply channel (20), and the second orifice (37) is in fluid communication with the first end (31) of the flow pressure supply channel (19). A land (32) is shown in FIG. 2 of the hydrostatic bearing (30). First side recess (34) and second side recess (35) are in fluid communication with at least a portion of the cutting insert (16) or the body (3). The tool (1), optionally has at least one coolant channel (21) positioned within a portion of the internal area (10) of the body (3), wherein the coolant channel (21) has a first end (23) and a second end (25) that is opposite of the first end (23). In certain embodiments of this invention, the second end (33, 43) of the flow pressure supply channel (19, 20, respectively) is in fluid communication with a reservoir supply (60), and wherein the reservoir supply (60) is in fluid communication with a reservoir supply conduit (61). The coolant conduit (61) is in fluid communication with a pump (38) or other flow/pressure device (not shown). The pump (38) or other flow/pressure device are elements that are known to those persons of ordinary skill in the art that customarily may be supplied with a cutting or turning tool. In certain embodiments of this invention, the tool (1) is a metal cutting tool, such as for example but not limited to, a turning tool. In certain embodiments of this invention, the cutting insert (16) of the tool (1) is either a blade or a drill tip. In certain embodiments of this invention, the second end (25) of the optional coolant channel (21) is in fluid communication with said supply reservoir (60). It will be appreciated by those persons of ordinary skill in the art that, the tool of this invention, in operational mode, will contain a fluid (not an element of this invention) in the supply reservoir (60). The fluid may be, for example, but not limited to, a lubricant or a cooling lubricant. In certain embodiments of this invention, the tool (1) includes wherein the first end (23) of the optional coolant channel (21) is in juxtaposition to the cutting insert (16). When the pump (38) of the tool (1) is placed in the “on” position (i.e. when the pump is operative (i.e. operational)), the pump (38) causes fluid, such as for example but not limited to, lubricant or cooling lubricant to flow from the reservoir supply conduit (61) into the supply reservoir (60) and into the flow pressure supply channel (19, 20) and into the first orifice (36) and the second orifice (37) and into the first end recess (34) and the second end recess (35). It will be understood by those persons of ordinary skill in the art that the flow of the lubricant or cooling lubricant is pressurized. The pressurized fluid, lubricant, or cooling lubricant then flows from the first end recess (34) and the second end recess (35) to at least a portion of the tool body (3) or the cutting insert (16) such that the pressurized fluid, lubricant, or cooling lubricant will come into communication with a workpiece (50), as set forth in FIG. 3, forming a hydrostatic bearing between the tool (1) and the workpiece (50), and preferable between the cutting insert (16) of the tool (1) and the workpiece (50). In certain embodiments of this invention, the pressurized fluid, lubricant, or cooling lubricant flows through at least one flow pressure supply channel (19, 20), respectively. Those persons of ordinary skill in the art will understand that the first end (17) of the cutting insert (16) of the tool (1) will be placed in communication with a workpiece (50) (see FIGS. 3 and 5). Preferably, the hydrostatic bearing effect provided by the tool (1) of this invention occurs between the first end (17) of the cutting insert (16) of the tool (1) and tool body (3) and the workpiece (50). The tool (1) of this invention in certain embodiments is a metal cutting tool, such as for example, but not limited to, a turning tool. In certain embodiments of this invention, the cutting insert (16) of the tool (1) is a blade or a drill tip.

Hydrostatic fluid (i.e. for example lubricant or cooling lubricant) supplied to the body (3) of the tool (1) by the hydrostatic bearing support (30) provides a film (90) of the hydrostatic fluid in the gap (70) between the cutting edge (40) of the cutting insert (16) and a workpiece (50). The fluid is ultimately supplied from a pump (38) in communication with a supply of fluid, lubricant, or cooling lubricant, under pressure and evenly distributed to the first end recess (34) and the second end recess (35). It will be understood by those persons of ordinary skill in the art that the fluid pressure is gradually decreasing from (a) the first orifice (36) to the first end recess (34) and (b) from the second orifice (37) to the second end recess (35), to atmospheric pressure, respectively.

There has been a need to design a tool (1) having this additional support of a hydrostatic bearing feed by a fluid, and in certain embodiments of this invention the fluid is a lubricant or a cooling lubricant, supplied by the tool (1). The first end recess (34) of the hydrostatic bearing support (30) is operatively coupled in fluid communication to the flow pressure supply channel (20), and the second end recess (35) of the hydrostatic bearing support (30) is operatively coupled in fluid communication to the flow pressure supply channel (19). In certain embodiments of the tool (1) of this invention, the pump (38) may be either internal to the tool (1) or be a pump (38) that is external to the tool (1). The supply reservoir (60) in certain embodiments of this invention may be internal to the tool (1) and in other embodiments the supply reservoir (60) is external to the tool (1). Those persons of ordinary skill in the art understand that the first orifice (36) and the second orifice (37) of the hydrostatic bearing support (30) each, independently, have a diameter that is smaller in size than the diameter of the hydraulic circuit delivering the fluid from the supply reservoir (60) to the first orifice (36) and the second orifice (37). The fluid is pressurized leaving (a) the first orifice (36) to the first end recess (34) and (b) the second orifice (37) to the second end recess (35). The flow of the fluid occurs out of the first end recess (34) and over the land (32) of the hydrostatic bearing support (30). The fluid flow rate, and gap (70), and film (90) thickness (see FIG. 3, right side, and FIG. 5) may be adjusted via the pump (38).

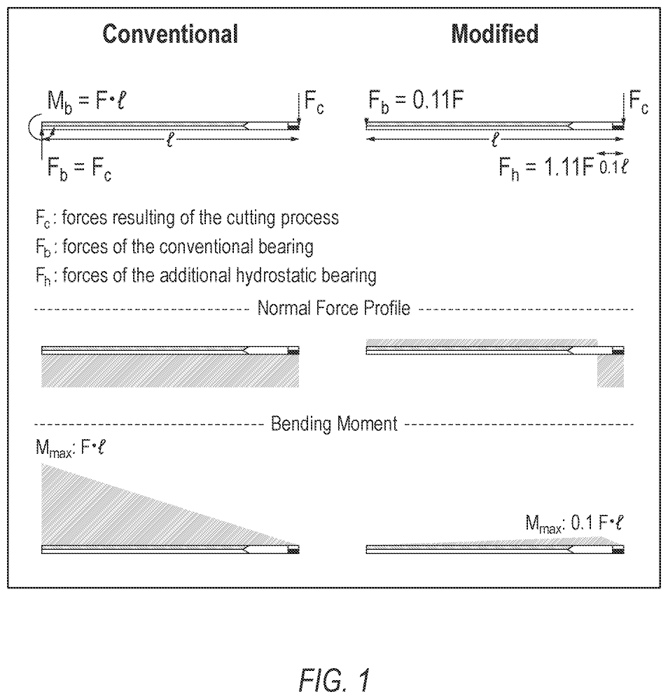

FIG. 1 shows the calculation of the bending moment for a supported case (i.e. use of the tool of this invention) and an unsupported case (i.e. a tool not having the hydrostatic bearing effect of the present invention). The additional bearing this case is at 1/10 of the length, reducing the bending moment by 89%. This results in a more stable cutting condition and enables longer and more filigree tools. FIG. 1 shows the benefits of an additional bearing in slender tools (a simplified calculation).

In certain embodiments, the cutting insert (16), may, of course, include other wear resistant materials such as natural diamond and thermally stable polycrystalline diamond material. The cutting insert (16) has one or more cutting edges (40) for contacting a workpiece (50) (see FIG. 3). The length and geometry of a cutting edge will depend on the specific design and application. The cutting edge (40) in certain embodiments of this invention may be curved, and circular in cross-section, but may be for example, but not limited to flat, chiseled, or beveled.

FIG. 1 shows that a hydrostatic bearing (30) provided by the tool (1) of this invention is a defined area of fluid to create a hydrostatic fluid bearing effect that establishes a film (90) of fluid between the cutting edge (40) of the cutting insert (16) and the workpiece (50) (see FIG. 3). FIG. 3 shows a certain embodiment of this invention wherein a cutting edge (40) of a blade (i.e. a cutting insert (16)) plunging into a workpiece (50), the workpiece (50) not part of the tool (1) of this invention. While FIG. 3 describes a blade as the cutting insert (16), it is equally applicable to a long (slender) drill (see FIG. 4). In certain embodiments of this invention, to ensure that a relevant amount of force can be transmitted by the hydrostatic bearing effect (FIG. 3, right side), at least one flow pressure supply channel (19, 20) is fed fluid, lubricant or cooling lubricant to their respective first ends (31, 41) where the fluid, lubricant or cooling lubricant ultimately exits at least one of the first end recess (34) and/or the second end recess (35) to create a film (90) on the workpiece (50). FIG. 3, left side, shows the gap (70) between a cut-off blade and workpiece (50) without the hydrostatic bearing effect provided by the tool (1) of this invention. FIG. 3, right side shows the gap (70) between a cut-off blade and workpiece (50) with the hydrostatic bearing effect provided by the tool (1) of this invention, and the film (90) provided between the cut-off blade and the workpiece (50) when using the tool (1) of this invention. The hydrostatic bearing effect provided by the tool (1) of this invention and the film (90) placed between the cutting edge (40) of the cutting insert (16), here the cut-off blade, counteracts the net radial imbalance force, and reduces the frictional forces between the cutting edge (40) and the workpiece (50). The reduction in friction also reduces wear on the cutting insert (16). Due to the bearing support (30) on opposing sides of the tool (1), the tool is kept in center, and the bending moment as well as vibrations are reduced. FIG. 4 shows a hydrostatic bearing effect in a modular drill tip. In a rotating drill bit application, the hydrostatic bearing effect provided by the tool (1) of this invention and the film (90) further reduces the tendency of a rotating drill bit to backwards whirl.

FIG. 5 shows an alternate embodiment of this invention, wherein the tool (1) has one flow pressure supply channel (19) that has two separate exits (80, 82), respectively, to feed the fluid, lubricant or cooling lubricant to the workpiece (50) creating a hydrostatic bearing between the tool (1) and the workpiece (50).

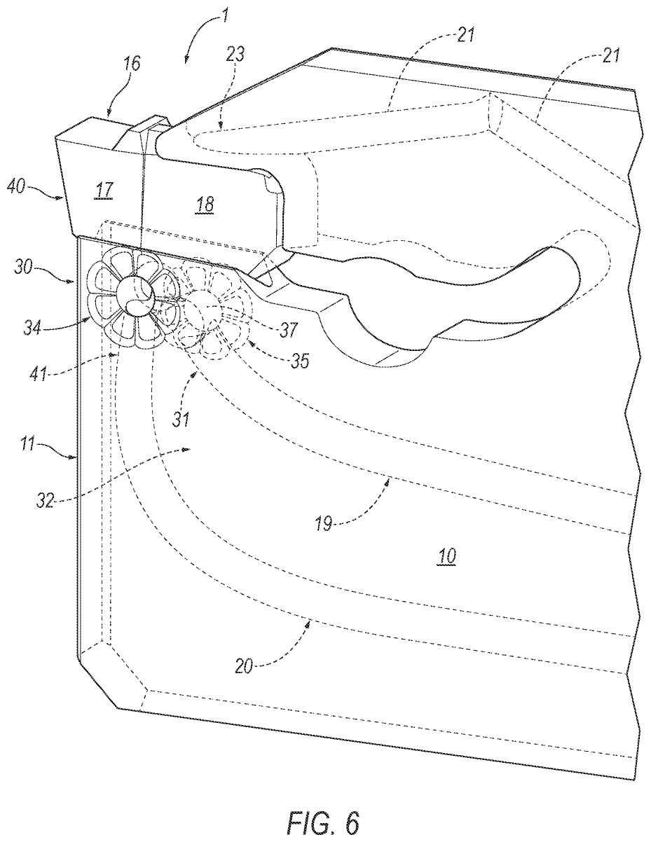

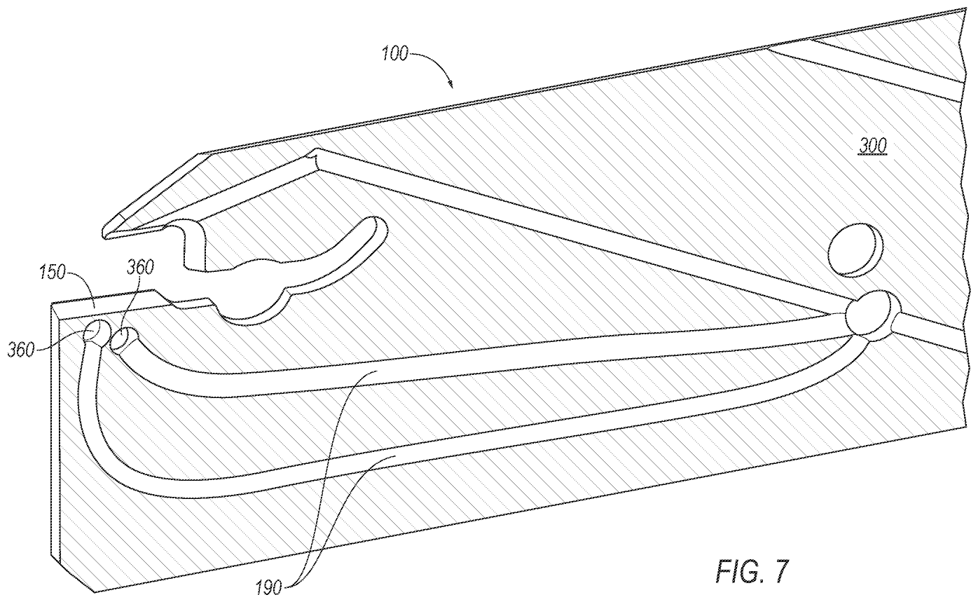

FIG. 6 shows an enlarged view of the internal area (10) of FIG. 2.

In certain embodiments of this invention the tool (1) is modular (with a cutting insert (16)) or is solid, made of hardened metal (steel) or a tungsten-carbide or cobalt.

In certain embodiments of this invention, the first side recess (34) and the second side recess (35) (i.e. exit points of the hydrostatic bearing support (30)) of the tool (1) are located close in proximity to or juxtaposition to where the force is entering the tool (1).

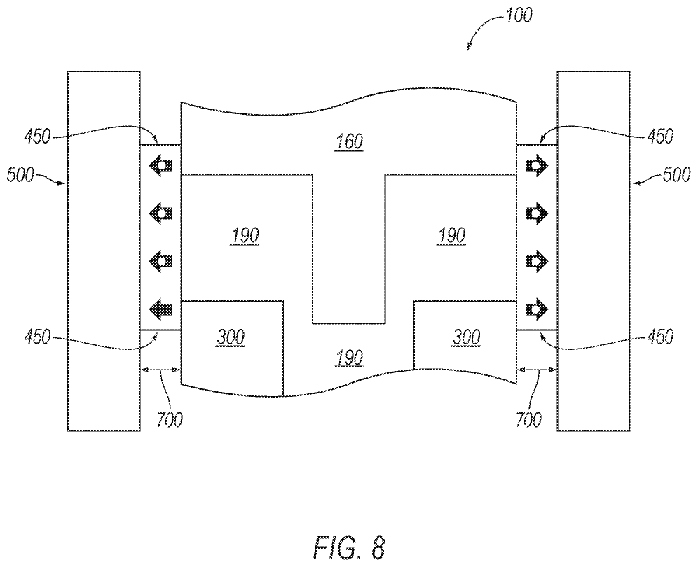

FIGS. 7 and 8 show another embodiment of this invention that is a metal cutting tool (100) comprising a body (300), said body (300) having a cutting edge (not shown) or an interface (150) for a cutting insert (not shown), at least one channel (190) supplying a pressurized fluid (0) from a machine tool (not shown) to a section (700) where said metal cutting tool (100) is engaging with a workpiece (500), and at least one orifice (360) that is in fluid communication with at least one said channel (190) to form at least one hydrostatic fluid bearing (450), wherein said hydrostatic fluid bearing (450) is created between said workpiece (500) and said metal cutting tool (100), and wherein said hydrostatic fluid bearing (450) having a stabilizing effect on said metal cutting tool (100). In certain embodiments, the metal cutting tool (100) wherein said one or more orifices (360) that result in a hydrostatic bearing effect are arranged in a way that each resulting force of said hydrostatic fluid bearing (450) are in balance. In certain embodiments, the metal cutting tool (100) wherein one or more of said orifices (360) that result in a hydrostatic bearing effect are arranged in a way that one or more forces of one or more of said hydrostatic fluid bearings (450) are balanced by other forces selected from the group of the bending of said metal cutting tool (100). In certain embodiments, the metal cutting tool (100) wherein each of said orifices (360) are located in proximity to said section (700) that is a cutting region. In certain embodiments, the metal cutting tool (100) has a shape that has a length that is long and slender compared to the metal cutting tool's width, having a length to a width diameter ratio greater than 5. In certain embodiments, the metal cutting tool (100) wherein one or more of said orifices (360) are strictly opposed to each other. In certain embodiments, the metal cutting tool (100) wherein two or more of said orifices (360) are slightly set off from each other to accommodate for design space limitations. In certain embodiments, the metal cutting tool (100) employs a coolant lubricant of a machine tool that is used in a metal cutting process, as a fluid to pressurize one or more of said hydrostatic fluid bearings (450).

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

For purposes of the description above, it is to be understood that the invention may assume various alternative variations and step sequences except where expressly specified to the contrary. Moreover, all numbers expressing, for example, quantities of ingredients used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A tool comprising a body, a cutting insert that is positioned at least partially within or on a first end of said body, at least one flow pressure supply channel positioned within at least a portion of an internal area of said body, wherein said flow pressure supply channel has a first end and a second end that is opposite to the first end of said flow pressure supply channel, a hydrostatic bearing positioned in the internal area of the body, wherein said first end of the flow pressure supply channel is in fluid communication with said hydrostatic bearing, and wherein said second end of the flow pressure supply channel is in fluid communication with a reservoir supply.

2. The tool of claim 1 wherein said reservoir supply is in fluid communication with a pump, and wherein said pump is either a part of said tool or is external to said tool, and wherein said pump transfers a lubricant or coolant under pressure to said reservoir supply through said flow pressure supply channel and to said hydrostatic bearing.

3. The tool of claim 1 wherein said hydrostatic bearing is in fluid communication with at least one of said body of said tool and said cutting insert.

4. A tool comprising a body, said body having a width, a length, and a height forming an internal area of said body, said body having a first end and a second end, and a middle section disposed between said first send and said second end of said body, a cutting insert having a first end and a second end that is opposite to the first end of said cutting insert, wherein said cutting insert is positioned at least partially on or within the first end of the body, and wherein said cutting insert has a cutting edge, a first flow pressure supply channel and a second flow pressure supply channel that are each positioned within at least a portion of said internal area of said body of said tool, wherein said each of said first flow pressure supply channel and said second flow pressure supply channel has a first end and a second end that is opposite to the first end of each of said first pressure supply channel and said second flow pressure supply channel, respectively, a hydrostatic bearing positioned in said internal area of said body, said hydrostatic bearing has a first side recess and a second side recess, wherein said first side recess is opposite to said second side recess, said hydrostatic bearing has a first orifice and a second orifice, said first orifice is opposite to said second orifice, and wherein said first orifice is in fluid communication with said first end of said first flow pressure supply channel, and said second orifice is in fluid communication with said first end of said second flow pressure supply channel, and wherein said hydrostatic bearing has at least one land, and wherein said first side recess and said second side recess are in fluid communication with at least a portion of said cutting insert and optionally a portion of said body, and wherein said first flow pressure supply channel and said second flow pressure supply channel are in fluid communication with a reservoir supply.

5. The tool of claim 4 wherein said reservoir supply is in fluid communication with a reservoir supply conduit, wherein said reservoir supply conduit is in fluid communication with a pump, wherein said pump is either a part of said tool or is external to said tool, and wherein said pump transfers a lubricant or coolant under pressure to said reservoir supply through at least one of said first flow pressure supply channel and said second flow pressure supply channel and to said hydrostatic bearing.

6. The tool of claim 4 including at least one coolant channel positioned within a portion of said internal area of said body, wherein said coolant channel has a first end and a second end that is opposite to said first end, and wherein said first send of said coolant channel is in fluid communication with said cutting insert and wherein said second end of said coolant channel is in fluid communication with a supply reservoir.

7. The tool of claim 6, wherein said reservoir supply is in fluid communication with a pump, wherein said pump is either a part of said tool or is external to said tool, and wherein said pump transfers a lubricant or coolant under pressure to said reservoir supply through said coolant channel and to said cutting insert.

8. The tool of claim 4 wherein said second end of said cutting insert is positioned within the body of the tool, and wherein a portion of said first end of said cutting insert and said cutting edge of the cutting insert protrude beyond said first end of said body.

9. The tool of claim 4 wherein said supply reservoir contains a fluid that is a lubricant or a cooling lubricant.

10. The tool of claim 4 wherein a hydrostatic effect occurs between said first end of said cutting insert and a workpiece when said tool is in operation.

11. A tool comprising a body, a cutting insert located on or within at least a portion of said body, at least one flow pressure supply channel located within said body, and a hydrostatic bearing located within said body, and wherein said flow pressure supply channel is in fluid communication with said hydrostatic bearing, and wherein said flow pressure supply channel is in fluid communication with a reservoir supply.

12. The tool of claim 11, wherein said reservoir supply is in fluid communication with a pump.

13. The tool of claim 12 wherein said pump is either a part of said tool or is external to said tool, and wherein said pump transfers a lubricant or coolant under pressure to said reservoir supply through said flow pressure supply channel and to said hydrostatic bearing.

14. The tool of claim 11 including a coolant channel that is in fluid communication with said cutting insert and said reservoir supply.

15. The tool of claim 14, wherein said reservoir supply is in fluid communication with a pump.

16. The tool of claim 15 wherein said pump is either a part of said tool or is external to said tool, and wherein said pump transfers a lubricant or coolant under pressure to said reservoir supply through said coolant channel and to said cutting insert.

17. The tool of claim 11 that is a metal cutting tool.

18. The tool of claim 17 that is a turning tool.

19. The tool of claim 17 that is a drill.

20. The tool of claim 11 that is produced by additive manufacturing.

21. The tool of claim 11 that is made of steel, tungsten carbide, or a cobalt alloy.

22. A cutting tool comprising a hydrostatic bearing support to minimize a bending moment of the tool when in use.

23. The cutting tool of claim 22 that is a metal cutting tool.

24. A metal cutting tool comprising a body, said body having a cutting edge or an interface for a cutting insert, at least one channel supplying a pressurized fluid from a machine tool to a section where said metal cutting tool is engaging with a workpiece, and at least one orifice that is in fluid communication with at least one said channel to form at least one hydrostatic fluid bearing, wherein said hydrostatic fluid bearing is created between said workpiece and said metal cutting tool, and wherein said hydrostatic fluid bearing having a stabilizing effect on said metal cutting tool.

25. The metal cutting tool of claim 24 wherein said orifices that result in a hydrostatic bearing effect are arranged in a way that each resulting force of said hydrostatic fluid bearings are in balance.

26. The metal cutting tool of claim 24 wherein said orifices that result in a hydrostatic bearing effect are arranged in a way that one or more forces of one or more of said hydrostatic fluid bearings are balanced by other forces selected from the group of the bending of said metal cutting tool.

27. The metal cutting tool of claim 24 wherein each of said orifices are located in proximity to said section that is a cutting region.

28. The metal cutting tool of claim 24 wherein said metal cutting tool has a shape that has a length that is long and slender compared to a width of said metal cutting tool, having a length to a width diameter ratio greater than 5.

29. The metal cutting tool of claim 24 wherein one or more of said orifices are strictly opposed to each other.

30. The metal cutting tool of claim 24 wherein two or more of said orifices are slightly set off from each other to accommodate for design space limitations.

31. The cutting tool of claim 24 wherein a coolant lubricant of said machine tool used in a metal cutting process, is employed as a fluid to pressurize one or more of said hydrostatic fluid bearings.
